(19) United States
(12) Patent Application Publication
(10) Pub. No.: US 2003/0050834 A1
(43) Pub. Date: Mar. 13, 2003

(54) System and method for dynamic customizable interactive portal active during select computer time

(76) Inventor: Sergio Caplan, New York, NY (US)

Correspondence Address: Rosenman & Colin LLP, 575 Madison Avenue, New York, NY, 10022-2585, US

(21) Appl. No.: 09/948,282

(22) Filed: Sep. 7, 2001

(51) Int. Cl. G06F 17/60

(52) U.S. Cl. 705/14

(57) ABSTRACT

A dynamic transactional broadcasting portal display screen application comprising a screensaver substitute activating during select computer time such as idle time. Sponsors or affinity groups can customize the functionality as well as “look and feel” of the portal application utilizing distributed networks including computers with broadband internet connection. The portal application logs into a distributed network including but not limited to a central network application to perform periodic updates of functionality and content. Content can comprise any combination of video, digital applications, still pictures and audio. The application is directed to a broadcast functionality for a distributed network application intercasting and guiding the users to experience directed digital information, incentivising users to buying activity on and off network, profiling users to provide affinity user selections and incentives to consumerism.

### FIELD OF THE INVENTION

This invention relates generally to the field of broadcasting, and more particularly to a system and method for a dynamic interactive portal active during computer idle time.

### BACKGROUND OF THE INVENTION

Web portals are a website or service that offers a broad array of resources and services, such as e-mail, forums, search engines and on-line shopping malls. The first Web portals were online services, such as AOL, that provided access to the Web, but by now most of the traditional search engines have transformed themselves into Web portals to attract and keep a larger audience.

Screen savers are known as small programs that take over the display screen if there are no keystrokes or mouse movements for a specified duration. Screen savers were originally developed to prevent ghosting, the permanent etching of a pattern on a display screen. For older monochrome monitors, ghosting often occurred if the same pattern was displayed on a display screen for a long period of time. Screen savers would prevent this by either blanking out the screen entirely or by displaying a constantly moving image. Modern display screens do not suffer so much from this problem. Today, therefore, screen savers are mostly an adornment, a way to liven up the computer. These screen savers fill the display with an image or animation until the user enters a password or a keystroke to begin using a computer again. This same space can be better utilized for true interaction.

A portal is merely a stepping stone to wherever a computer user desires to go to next on the computer. Portals provide search engines as well as links to popular sites. A weak aspect of a portal is that a computer user must enter a portal first to go to it first and weed through the items one does not want. Current portals have over 100 hyperlinks per page. Screensaver use began back when monitors had no power management routines. In time, the screensaver became a form of entertainment. But what both current portals and screensaver lack is a “broadcast sensibility” that the television and radio industry have developed so well during the 20th century or the interactivity of an inter and intranetworked peer-to-peer global community.

The Internet is a shared resource, a cooperative network built out of millions of hosts all over the world. Today there are more applications than ever that want to use the network, consume bandwidth, and send packets far and wide, placing strain on the most basic of resources: network bandwidth. The increasing reliance on the Internet for critical applications has brought with it new security requirements, resulting in firewalls that strongly partition the Net into pieces and the system has scaled vastly beyond its original design.

Through the music-sharing application called Napster and the larger movement dubbed “peer-to-peer,” the millions of users connecting to the Internet have started using their ever more powerful desktop computers and internet device nodes for more than just browsing the Web and trading e-mail. Instead, machines in the home, PDAs, the desktop and internet access devices are connecting to each other directly, forming groups and collaborating to become user-created search engines, virtual supercomputers, and filesystems.

A technical challenge exists. Many network providers, having set up their systems with the idea that users would spend most of their time downloading data from central servers, have economic objections to peer-to-peer models.

The Internet was initially designed as a peer-to-peer system. Over time it has become increasingly client/server, with consumer clients communicating with a relatively privileged set of servers. The current crop of peer-to-peer applications is using the Internet much as it was originally designed: as a medium for communication for machines that share resources with each other. Providing challenges of implementation into internetworked nodes from a common hook point involves challenges of scale, roll out and implementation and calls for an application that incentivises user participation analogous to the most ubiquitous medium of communication of the last century: broadcast, yet with the new ability to contribute collaboratively to the network and not passively receive information and content.

The Internet was initially conceived in the late 1960s as a peer-to-peer system. The goal of the original ARPANET was to share computing resources around the U.S. addressing how to integrate different kinds of existing networks as well as future technologies with one common network architecture that would allow every host to be an equal player.

The early Internet was also much more open and free than today's network. Firewalls were unknown until the late 1980s. Generally, any two machines on the Internet could send packets to each other. The Net was a communications medium of cooperative researchers who generally did not need protection from each other. The protocols and systems were obscure and specialized enough that security break-ins were rare. The modern Internet is much more partitioned.

FTP and Telnet, were themselves client/server applications. A Telnet client logged into a compute server and an FTP client sent and received files from a file server. But while a single application was client/server, the usage patterns, as a whole, were symmetric. Every host on the Net could FTP or Telnet to any other host, and in the early days of minicomputers and mainframes, the servers acted as clients as well—a basic symmetry which made the Internet truly innovative. The Internet's distributed network in turn enabled a variety of more complex systems such as Usenet and DNS that used peer-to-peer communication patterns.

Two long-established fixtures of computer networking that include important peer-to-peer components are Usenet and DNS. Known Usenet news implements a decentralized model of control that, in some ways, is the predecessor of today's peer-to-peer applications such as Gnutella and Freenet. At its core, Usenet is a system that, without a central control, copies files between computers. Usenet has been known since 1979 and was originally based on a facility called the Unix-to-Unix-copy protocol, or UUCP. UUCP was a mechanism by which one Unix machine would automatically dial another, exchange files with it, and disconnect. This mechanism allowed Unix sites to exchange e-mail, files, system patches or other messages. The Usenet grew from these original two hosts to thousands of sites. As the network grew, the number and structure of the topics in which a message could be posted grew as well. Currently Usenet uses a TCP/IP-based protocol known as the Network News Transport Protocol (NNTP), which allows two machines on the Usenet network to discover new newsgroups efficiently and exchange new messages in each group.

The known Usenet provides an amount of local control and relatively simple administration. A Usenet site joins the rest of the world by setting up a news exchange connection with at least one other news server on the Usenet network. Today, exchange is typically provided by a company's ISP. The administrator tells the company's news server to get in touch with the ISP's news server and exchange messages on a regular schedule. Company employees contact the company's local news server and transact with it to read and post news messages. For example, when a user in the company posts a new message in a newsgroup, the next time the company news server contacts the ISP's server, it will notify the ISP's server that it has a new article and then transmit that article. At the same time, the ISP's server sends its new articles to the company's server.

The volume of Usenet traffic is vast, and not every server will want to carry the full complement of newsgroups or messages. For example, the company administrator can control the size of the news installation by specifying which newsgroups the server will carry. In addition, the administrator can specify an expiration time by group or hierarchy, so that articles in a newsgroup will be retained for that time period, but no longer. These controls allow each organization to voluntarily join the network on its own terms.

Usenet has evolved a number of examples of decentralized control structures on the Net. There is no central authority that controls the news system. The addition of new newsgroups to the main topic hierarchy is controlled by a rigorous democratic process, using the Usenet group news.admin to propose and discuss the creation of new groups. After a new group is proposed and discussed for a set period of time, anyone with an e-mail address may submit an e-mail vote for or against the proposal. If a newsgroup vote passes, a new group message is sent and propagated through the Usenet network.

NNTP as a protocol, for example, contains a number of optimizations of modern peer-to-peer systems. For instance, news messages maintain a “Path” header that traces their transmission from one news server to another. If news server A receives a request from server B, and A's copy of a message lists B in the Path header, A will not try to retransmit that message to B. Since the purpose of NNTP transmission is to make sure every news server on Usenet can receive an article (if it wants to), the Path header avoids a flood of repeated messages. Gnutella, as an example, does not use a similar system when transmitting search requests so as a result a single Gnutella node can receive the same request repeatedly.

Usenet's systems for decentralized control, its methods of avoiding a network flood, and other characteristics demonstrate principles for improvement of peer-to-peer systems.

The Internet was built out of peer-to-peer communication patterns. We can draw knowledge about how to design new peer-to-peer systems from these patterns. Explosive growth led to the increasing deployment of firewalls on the Net and the growth of asymmetric network links such as ADSL and cable modems. The network model of user applications—not just their consumption of bandwidth, but also their methods of addressing and communicating with other machines—changed significantly with the rise of the commercial Internet and the advent of millions of home users in the 1990s. Modem connection protocols such as SLIP and PPP became more common; typical applications targeted slow-speed analog modems, and corporations began to manage their networks with firewalls and Network Address Translation (NAT). The Internet is based on 32-bit IP (Internet Protocol) addresses, which means the theoretical maximum number of computers on the Internet is 4 billion or so. The practical limit is much lower, due to inefficiencies in how IP addresses are used. In fact, the Internet may be only a few years away from running out of IP addresses.

As IP addresses become scarce, a technique known as Network Address Translation, or NAT, was developed to allow the use of a single IP address for a whole network of computers. A NAT sits in-between the public Internet and the network it serves, and works by rewriting IP addresses and port numbers in IP headers on the fly so the packets all appear to be coming from (or going to) the single public IP address of the NAT device instead of the actual source or destination. NAT is now commonly employed in small home-office routers and in software used by consumers to connect several personal computers to a single cable modem. It is even used by some Internet Service providers. NAT is not the only possible solution; proxy servers are also commonly used, but require more configuration, and sometimes require custom client software. Eventually IPv6, with 128-bit addresses and will solve the problem once and for all.

Many of these changes were built around the usage patterns common at the time, most of which involved downloading data, not publishing, or uploading information.

The web browser, and many of the other applications that arose during the early commercialization of the Internet, were based around a simple client/server protocol: the client initiates a connection to a well-known server, downloads some data and disconnects. When the user is finished with the data retrieved, the process is repeated. The model is simple and straightforward. It works for everything from browsing the Web to watching streaming video, and developers cram shopping carts, on-demand maps, stock transactions, interactive games and a host of other applications into it. The machine running a web client does not need to have a everlasting or well-known address. It does not need a continuous connection to the Internet. It does not need to accommodate multiple users. It just needs to know how to ask a question and listen for a response.

Some applications are not so clearly bi-lateral. E-mail, for instance, requires much more two-way communication between an e-mail client and server. In these cases, though, the client is often talking to a server on the local network (either the ISP's mail server or a corporate one). Chat systems which have achieved widespread usage, such as AOL's Instant Messenger, have similar “local” properties, and Usenet systems do as well. As a result, the typical ISP configuration instructions give detailed instructions for e-mail, news, and sometimes chat. These were the exceptions that were worth some manual configuration on the user's part. The “download” model is simpler and works without much configuration; the “two-way” model is used less frequently but perhaps to greater effect.

While early visions of the Web always called it a great equalizer of communications—a system that allowed every user to publish their viewpoints rather than simply consume media—the commercial explosion on the Internet quickly fit the majority of traffic into the downstream paradigm already used by television and newspapers. Architects of the systems that enabled the commercial expansion of the Net often took the downstream model into account, assuming that it was here to stay.

Addressing true decentralized node to node interaction with a broadcast system that is easy to install is a problem solved by the disclosed invention within one embodiment a peer-to-peer application to help these downstream systems to change.

Allowing an Internet host to be only a client, not a server, is a theme that runs through a lot of the development of the Internet. With the rise of modem users connecting to the Internet, the old practice of giving every Internet host a fixed IP address became impractical, because there were not enough IP addresses to go around. Dynamic IP address assignment is now the norm for many hosts on the Internet, where an individual computer's address may change every single day. Broadband providers are even finding dynamic IP useful for their “always on” services. The end result is that many hosts on the Internet are not easily reachable, because they keep moving around. Peer-to-peer applications such as instant messaging or file sharing have to work hard to circumvent this problem, building dynamic directories of hosts.

A final trend is to not even give a host a valid public Internet address at all, but instead to use NAT to hide the address of a host behind a firewall. NAT combines the problems of firewalls and dynamic IP addresses: not only is the host's true address unstable, it is not even reachable! All communication has to go through a fairly simple pattern that the NAT router can understand, resulting in a great loss of flexibility in applications communications. For example, many cooperative Internet games have trouble with NAT: every player in the game wants to be able to contact every other player, but the packets cannot get through the NAT router. The result is that a central server on the Internet has to act as an application-level message router, emulating the function that TCP/IP itself used to serve. The disclosed invention achieves a game service which optimizes network utilization.

Firewalls, dynamic IP, and NAT grew out of a clear need in Internet architecture to make scalable, secure systems solving the problem of bringing millions of client computers onto the Internet quickly and manageably, relegating most computers to second-class status as clients only.

As peer-to-peer applications that securely incentivizes usage while providing easy installation, broadcasting and security are an architecture provided by the disclosed invention, which securely allows nodes to contribute power to the network, demanding that participants serve resources as well as use them. The rise in asymmetric network connections such as ADSL and cable modems are a result of trying to get the most efficiency out of available wiring, and broadband providers have chosen to provide asymmetric bandwidth. A typical ADSL or cable modem installation offers three to eight times more bandwidth when getting data from the Internet than when sending data to it, favoring client over server usage.

This has been tolerated by most users, for the Web is the killer application for the Internet, and most users are only clients of the Web, not servers. Most users who publish their own web pages typically do not do so from a home broadband connection, but instead use third-party dedicated servers provided by companies like GeoCities or Exodus. In the end most Web use is itself asymmetric—many clients, few servers—with most users being served by asymmetric bandwidth which the disclosed invention will optimize using all available network resources.

Peer-to-peer applications change the assumption that end users only want to download from the Internet, never upload to it. File-sharing applications such as Napster or Gnutella can reverse the bandwidth usage, making a machine serve many more files than it downloads. The upstream pipe cannot meet demand. Even worse, because of the details of TCP's rate control, if the upstream path is clogged, the downstream performance suffers as well. So if a computer is serving files on the slow side of a link, it cannot easily download simultaneously on the fast side.

Peer-to-peer technology makes every host act both as a client and a server; and the asymmetric assumption is incorrect. There is not much an individual peer-to-peer application can do to work around asymmetric bandwidth, a challenge overcome in part by the inventions time-based sequencing of information.

Peer-to-peer allows us to separate the concepts of authoring information and publishing that same information. Peer-to-peer allows for decentralized application design.

One of the promises of the Internet is that people are able to be their own publishers, for example, by using personal web sites to make their views and interests known. Self-publishing has certainly become more common with the commercialization of the Internet. More often, however, users spend most of their time reading (downloading) information and less time publishing, and as discussed previously, commercial providers of Internet access have structured their offering around this asymmetry. The example of Napster creates an interesting middle ground between the ideal of “everyone publishes” and the seeming reality of “everyone consumes.” Napster particularly (and famously) makes it very easy to publish data a user did not author. In effect, your machine is being used as a repeater to retransmit data once it reaches you. A network designer, assuming that there are only so many authors in the world and therefore that asymmetric broadband is the perfect optimization, is confounded by this development. Napster changes the flow of data. The assumptions that servers would be owned by publishers and that publishers and authors would combine into a single network location have proven untrue. The same observation also applies to Gnutella, Freenet, and others. Users do not need to create content in order to want to publish it—in fact, the benefits of publication by the “reader” have been demonstrated by the scale some of these systems have been able to reach. To allow a broadcaster to provide incentives and transmit their content without consuming bandwidth is resolved in part by the disclosed inventions broadcast server utilizing peer-to-peer delivery to intercast content and applications as needed across the screensaver application space.

DNS is a known peer-to-peer protocol design, but with a built-in sense of hierarchy. Semi-centralized organization in application, such as Usenet, instant messaging and Napster is possible, and the disclosed inventions system and method achieves a preferred peer-to-peer as needed.

Usenet is an instructive example of the evolution of a decentralized system. Usenet propagation is symmetric: hosts share traffic. But because of the high cost of keeping a fill news feed, in practice there is a backbone of hosts that carry all of the traffic and serve it to a large number of “leaf nodes” whose role is mostly to receive articles. Within Usenet, there was a natural trend toward making traffic propagation hierarchical, even though the underlying protocols do not demand it. This form of “soft centralization” may prove to be economic for many peer-to-peer systems with high-cost data transmission.

To a user of an instant messaging system, the application appears peer-to-peer, sending data directly to the friend being messaged. But all major instant messaging systems have some sort of server on the back end that facilitates nodes talking to each other. The server maintains an association between the user's name and his or her current IP address, buffers messages in case the user is offline and routes messages to users behind firewalls. Some systems (such as ICQ) allow direct client-to-client communication when possible but have a server as a fallback. A fully decentralized approach to instant messaging would not work on today's Internet, but there are scaling advantages to allowing client-to-client communication when possible.

Napster is an example of a hybrid system. Napster's file sharing is decentralized: one Napster client downloads a file directly from another Napster client's machine. But the directory of files is centralized, with the Napster servers answering search queries and brokering client connections. This hybrid approach seems to scale well: the directory can be made efficient and uses low bandwidth, and the file sharing can happen on the edges of the network.

Applications that require centralized information sharing for accountability or correctness are hard to spread out on a decentralized network. For example, an auction site needs to guarantee that the best price wins; that can be difficult if the bidding process has been spread across many locations. Security is another design challenge, addressed by the disclosed invention.

Known firewalls are an attempt to secure unwanted transmissions. Naive firewalls utilized to secure open communications to protect hostile information transfer are often unaware that they are passing the exact sorts of traffic the network administrator intended to block.

The problem is twofold. First, there is no good way for a firewall to identify what applications are running through it. A port number may have already been circumvented. Fancier firewalls can analyze the actual traffic going through the firewall and see if it is a legitimate HTTP stream, but that just encourages application designers to masquerade as HTTP, leading to an escalating arms race that benefits no one.

The second problem is that even if an application has a legitimate reason to go through the firewall, there is no simple way for the application to request permission. As long as a firewall allows some sort of traffic through, peer-to-peer applications will find a way to slip through that opening.

The Internet was designed with peer-to-peer applications in mind, but as it has grown the network has become more asymmetric. Firewalls make it hard to contact hosts; dynamic IP and NAT make it nearly impossible. Asymmetric bandwidth is holding users back from efficiently serving files on their systems. Firewalls serve an important need: they allow administrators to express and enforce policies about the use of their networks. That need will not change with peer-to-peer applications.

The disclosed invention allows a level of sophistication allowing systems behind the firewall to ask permission to run a particular peer-to-peer application. The disclosed invention is more flexible and more tied toward applications rather than simple port numbers balancing the demands and power of a decentralized network and the central control point of an Operating System.

Problems engendered by dynamic IP and NAT already have a technical solution: IPv6. This new version of IP, the next generation Internet protocol architecture, has a 128-bit address space—enough for every host on the Internet to have a permanent address. Eliminating address scarcity means that every host has a home and, in theory, can be reached. The main thing holding up the deployment of IPv6 is the complexity of the changeover. will be commonly deployed, but without it peer-to-peer applications will continue to need to build alternate address spaces to work around the limitations set by NAT and dynamic IP—a problem solved by the disclosed application.

Peer-to-peer applications stress the bandwidth usage of the current Internet. First, they break the assumption of asymmetry upon which today's ADSL and cable modem providers rely. Broadband connections will catch up. Data caching is an optimization for any peer-to-peer application that is transmitting bulk data; it would be a significant advance to make sure that a program does not have to retransmit or resend data to another host a problem solved in the disclosed application.

If a user runs a Gnutella node at home, they may want to specify that it can use only 50% of my bandwidth. Current operating systems and programming libraries do not provide good tools for this kind of limitation, yet the disclosed peer-to-peer applications demands network resources from hosts, and allows users tools to control that resource usage.

Usenet breaks down because it is impossible to hold people accountable for their actions. The disclosed system has a means to identify users and the system can be made more secure against antisocial behavior.

Peer-to-peer systems solve the challenge of integrating local administrative control with global system correctness. Usenet allowed a local news administrator to set policy for his or her own site, allowing the application to be customized to each user group's needs. The shared communication channel of news.admin allows a community governance procedure for the entire Usenet community.

The disclosed preferred peer process allows mechanisms of local and global control. Analogous to Usenet from the beginning, allows correct behavior. The Internet began as a fully symmetric, peer-to-peer network of cooperating users. As the Net has grown to accommodate the burgeoning traffic, safeguarding barriers have been attempted to put in place that have split the Net up into a system with relatively few servers and many clients, a “walled garden.”

An application such as the disclosed invention allows for robust broadcast of content across a secure global distributed network providing incentives for user participation.

### SUMMARY OF THE INVENTION

In view of some of the drawbacks of the primary object of the invention is to provide a customizable dynamic “broadcast oriented” application for the World Wide Web and an interactive space that responds to clusters of preferred users with the application conserving bandwidth as needed.

Another object of the invention is to provide digital programming such as video via the screensaver application, and functionality for a network comprising as well the broadband market, utilizing peer-to-peer to preferred node as needed, conserving bandwidth and reliance on any single node.

Another object of the invention is to allow licensors of the application to utilize the invention for their own content programming and video advertising.

Another object of the invention is to provide marketers the ability to reach an audience by delivering customized relevant video, audio, and other information.

Another object of the invention is to provide marketers the ability to reach an audience by always being part of the client's computer desktop or any OS application environment, whether in the form of a dynamic portal replacing the screensaver or as an alert icon sitting in the system tray.

Another object of the invention is to provide marketers the ability to reach an audience by being able to send survey questions electronically to the system, by allowing a client to answer the survey at his leisure.

Another object of the invention is to allow for customization of the content that is being ‘transmitted’ to the user's screen utilizing ‘idle’ time and conserving bandwidth.

Another object of the invention is to allow for clients (computers running the portal) to attempt to serve files to each other before going straight to a central server, thereby not always relying on a hierarchical bandwidth consumption at the central server.

Another object of the invention is to allow for clients (computers running the portal which can be desktop, handheld, embedded, wired or wireless) to maintain and run their own database (peer-to-peer), eliminating the requirement for a massive computer complex at the central server for the processing of on-demand database queries.

Another object of the invention is to provide a preferred peer-to-peer broadcasting application network with affinity incentives.

Another object of the invention is to provide a prioritized peer broadcasting application within a VPN (Very Private Network).

Another object is to provide a real-time rules based server-client peer-to-peer application capable of contacting the proximate computers on a network, with a client peer requesting information that has been determined by application of the rules in a previous, local, peer run of a process.

Another object of the invention is to provide a local rules based database which “fetches” to a server or other nodes to find nodes with active content and pushes needed content to nodes requiring additional required content and applications based upon rules.

In accordance with one embodiment of the process, a decentralized or in part centralized network in which multiple clients connect to view high-speed, always on connection, whereas the client software activates after predefined timeout periods. The client software disables any installed screensavers, delivering to the screen a media rich, dynamic portal, comprising any combinations of video, stills and audio or other digital content. The process provides to the user a dynamic toolbar which is customized for each individual screen, thereby making the portal complete as each screens toolbar will transport the user to multiple predefined websites, all dynamically updated and transformed with each new screen. Embedded into each toolbar are static functions which remain the same, VCR type controls, audio and automatic mute features, specialty functionality such as buttons added to the dynamic status of each screen, as specially coded screens contain the ability to offer one to one or one to many promotions, special discounts, sample give-aways and even contest prizes. All movements and decisions made by the user are being recorded and distributed over the Internet or other network, in one embodiment, to a preferred node on a network, where each user profile is cataloged and a dynamic demographic database is created for sampling, analysis and application functionality enhancement.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIGS. 1A-F is a flow chart in accordance with a preferred embodiment of the present invention;

FIG. 2 is a plan view of a sample still or video screen, as well as the dynamic toolbar in accordance with a preferred embodiment of the present invention;

FIG. 3 is a plane view of a dynamic tool bar in accordance with a preferred embodiment of the present invention; and

FIG. 4 is a System and Method Overview.

### DETAILED DESCRIPTION OF THE PREFERRED EMBODIMENTS

Detailed description of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The OSI or Open System Interconnection model as shown in the below table defines a networking framework for implementing protocols in seven layers which the disclosed system and method works across. Control of the disclosed system and process is passed from one layer to the next, starting at the application layer in one station, proceeding to the bottom layer, over the channel to the next station and back up the hierarchy.

OPEN SYSTEM INTERCONNECTION MODEL

| | |
|---|---|
| Physical | This layer conveys the bit stream - electrical impulse, light |
| (Layer 1) | or radio signal - through the network at the electrical and |
| | mechanical level. It provides the hardware means of send- |
| | ing and receiving data on a carrier, including defining ca- |
| | bles, cards and physical aspects for the disclosed invention. |
| Data Link | At this layer for the disclosed invention, data packets are |
| (Layer 2) | encoded and decoded into bits. It furnishes transmission |
| | protocol knowledge and management and handles errors in |
| | the physical layer, flow control and frame synchronization. |
| | The data link layer is divided into two sublayers: The |
| | Media Access Control (MAC) layer and the Logical Link |
| | Control (LLC) layer. The MAC sublayer controls how a |
| | computer on the network gains access to the data and |
| | permission to transmit it. The LLC layer controls frame |
| | synchronization, flow control and error checking for the |
| | disclosed invention. |
| Network | This layer provides switching and routing technologies, |
| (Layer 3) | creating logical paths, known as virtual circuits, for trans- |
| | mitting data from node to node. Routing and forwarding |
| | are functions of this layer, as well as addressing, inter- |
| | networking, error handling, congestion control and packet |
| | sequencing of the disclosed invention. |
| Transport | This layer provides transparent transfer of data between end |
| (Layer 4) | systems, or hosts and is responsible for end-to-end error |
| | recovery and flow control. It ensures complete data transfer |
| | of the disclosed invention. |
| Session | This layer establishes, manages and terminates connections |
| (Layer 5) | between applications of the disclosed invention. The session |
| | layer sets up, coordinates, and terminates conversations, |
| | exchanges and dialogues between the applications at each |
| | end. It deals with session and connection coordination of |
| | the disclosed invention. |
| Presentation | This layer provides independence from differences in data |
| (Layer 6) | representation (e.g., encryption) by translating from dis- |
| | closed invention application to network format and vice |
| | versa. This layer formats and encrypts data to be sent |
| | across a network, providing freedom from compatibility |
| | problems. It is known as the syntax layer. |
| Application | This layer supports application and end user.html end-user |
| (Layer 7) | processes. Communication partners are identified, quality of |
| | service is identified, user authentication and privacy are |
| | considered, and any constraints on data syntax are identi- |
| | fied. Everything at this layer is application-specific. This |
| | layer provides application services for file transfers, e-mail, |
| | and other network software services of the disclosed |
| | invention. |

A Centralized Server is provided, which could be any high end server hardware capable of handling multiple connections efficiently. High capacity storage media is utilized to allow for the handling of tens of thousand of stills, videos, digital data as well as a large database.

Application software running on servers would be any known third party web server software. Software acts as a web server running for example on port 80. The database could in one embodiment comprise a SQL language database which would simplify the creation of reports. Customized software to monitor the posting of IP addresses as nodes log on to the server as well as poll all nodes activity logs and pass posting of the IP addresses in an organized fashion to the database is incorporated. Software can be written in any computer language as well as OOP (object orientated programming) languages: C, C++, Visual Basic, Java, and other languages that would be able to communicating with a SQL database.

A Game Server is provided which could be a single computer connected via a network to a centralized server database. In one embodiment this hardware can be a known desktop computer.

Customized software is provided to randomly chose IP addresses and select IP addresses for incentive oriented prizes or offers. Such software can be written in any computer language: C, C++, Visual Basic, Java, and other languages able to communicate with a SQL database.

Applications can reside on client nodes such that custom software will be able to work on the known hardware. Software applications can be written in any computer language such as C, C++, Visual Basic, Java, and other languages that would be combined with third party libraries that already have built in low-lever graphics, communications, and database functions.

The disclosed invention utilizes a robust peer-to-peer Internet standard comprising TCP/IP, HTTP and port 80 as well as other ports on an application determined basis. SQL database technology can be utilized for storage windows media player for digital streaming across a peer-to-peer network for intercasting with in one embodiment but not limited to a centralized server for backing up the peer-to-peer intercasting.

The disclosed invention's peer-to-peer systems go hand-in-hand with decentralized systems. In a fully decentralized system, not only is every host an equal participant, but there are no hosts with special facilitating or administrative roles. In practice, building fully decentralized systems can be difficult, and many peer-to-peer applications take hybrid approaches to solving problems. The disclosed peer-to-peer applications presents a decentralized face while relying on a, as needed, central facilitator to coordinate operations which is achievable in one embodiment of the disclosed invention. For example, the disclosed invention's file sharing is decentralized.

Decentralization engenders a whole new area of network-related failures: unreliability, incorrect data synchronization, etc. The robust peer-to-peer design of the disclosed invention balances the power of peer-to-peer models against the complications and limitations of decentralized systems. Caching is a well understood technology: the disclosed inventions distributed caches resolves many of the consistency and load sharing issues that peer-to-peer applications face.

The disclosed peer-to-peer application has effective means for allowing users to control the bandwidth the application uses. The disclosed application also allows for accountability and the enforcement of community standards. For example, the application will not let 5000 people download from the same client at the same time and it will not let 5000 download from a client in one day, even one at a time.

Domain Name System (DNS) is a known example of a system that blends peer-to-peer networking with a hierarchical model of information ownership which had scaled, from the few thousand hosts it was originally designed to support in 1983 to the hundreds of millions of hosts currently on the Internet.

DNS was established as a possible solution to a file-sharing problem. In the early days of the Internet, the way to map a human-friendly name like bbn to an IP address like 4.2.49.2 was through a single flat file, hosts.txt, which was copied around the Internet periodically. As the Net grew to thousands of hosts and managing that file became impossible, DNS was developed as a way to distribute the data sharing across the peer-to-peer Internet.

The namespace of DNS names is naturally hierarchical. For example, Mode11.com owns the namespace www.mode11.com: they are the sole authority for all names in their domain, such as www.Mode11.com. This built-in hierarchy yields a simple, natural way to delegate responsibility for serving part of the DNS database. Each domain has an authority, the name server of record for hosts in that domain. When a host on the Internet wants to know the address of a given name, it queries its nearest name server to ask for the address. If that server does not know the name, it delegates the query to the authority for that namespace. That query, in turn, may be delegated to a higher authority, all the way up to the root name servers for the Internet as a whole. As the answer propagates back down to the requestor, the result is cached along the way to the name servers so the next fetch can be more efficient. Name servers operate both as clients and as servers.

DNS scales well and several key design elements in DNS can be replicated in many distributed systems today. One element is that hosts can operate both as clients and as servers, propagating requests when need be. These hosts help make the network scale well by caching replies. The second element is a natural method of propagating data requests across the network. Any DNS server can query any other, but in normal operation there is a standard path up the chain of authority. The load is naturally distributed across the DNS network, so that any individual name server needs to serve only the needs of its clients and the namespace it individually manages.

A fundamental design principle of the Internet as incorporated in the Mode11.com system and method is best effort packet delivery. “Best effort” means the Internet does not guarantee that a packet will get through, simply that the Net will do its best to get the packet to the destination. Higher-level protocols such as Transmission Control Protocol (TCP) create reliable connections by detecting when a packet gets lost and resending it. A major reason packets do not get delivered on the Internet is congestion: if a router in the network is overwhelmed, it will start dropping packets at random. TCP accounts for this by throttling the speed at which it sends data. When the network is congested, each individual TCP connection independently slows down, seeking to find the optimal rate while not losing too many packets. But not only do individual TCP connections optimize their bandwidth usage, TCP is also designed to make the Internet as a whole operate efficiently. The collective behavior of many individual TCP connections backing off independently results in a lessening of the congestion at the router, in a way that is tuned to use the router's capacity efficiently. In essence, the TCP backoff algorithm is a way for individual peers to manage a shared resource without a central coordinator.

The problem is that the efficiency of TCP on the Internet scale fundamentally requires cooperation: each network user has to play by the same rules. The performance of an individual TCP connection is inversely proportional to the square root of the packet loss rate—part of the “TCP rate equation,” a fundamental governing law of the Internet. Protocols that follow this law are known as “TCP-friendly protocols” which are incorporated in the disclosed system and method of Mode11.com It is possible to design other protocols that do not follow the TCP rate equation, ones that rudely try to consume more bandwidth than they should.

An early example was a feature added by known Netscape™ to their browser—the ability to download several files at the same time. The Netscape™ engineers discovered that if you downloaded embedded images in parallel, rather than one at a time, the whole page would load faster and users would be happier. Not only does it tax the server to have to send out more images simultaneously, but it also creates more TCP channels and sidesteps TCP's congestion algorithms. Netscape released the client and people discovered in practice that the parallel download strategy did not unduly harm the Internet. Today this technique is standard in all browsers and goes unquestioned. The questions have reemerged at the new frontier of “download accelerator” programs that download different chunks of the same file simultaneously, again threatening to upset the delicate management of Internet congestion.

A more troubling challenge is the management of bandwidth-hungry streaming broadband media, a challenge overcome by the disclosed system and method. Typical streaming media applications do not use TCP, instead favoring custom UDP-based protocols with their own congestion control and failure handling strategies. Many of these protocols are proprietary; network engineers do not even have access to their implementations to examine if they are TCP-friendly.

Known Spam and the TCP rate algorithm both demonstrate that the proper operation of the Internet is fragile and requires an application that can solve broadcast information, peer-to-peer cooperation and a application that can easily be installed at any node a design achievement of the disclosed system and method.

In the case of TCP, the system has preserved. In the case of spam the battle goes on. A system can be designed such that they do not require cooperation to function correctly, or incentivise cooperation by rewarding appropriate behavior or auditing usage to enable all nodes enjoyment of the distributed network such as incorporated into the disclosed system and method.

As the cooperative nature of the Internet was being threatened, network administrators implemented a variety of management measures that resulted in the Internet being a much less open network. In the early days of the Internet, all hosts were equal participants. The network was symmetric—if a host could reach the Net, everyone on the Net could reach that host. Every computer could equally be a client and a server. The deployment of firewalls, the rise of dynamic IP addresses, and the popularity of Network Address Translation (NAT) were a response to the need to secure the network, to protect individual hosts from unlimited access. By default, any host that can access the Internet can also be accessed on the Internet. Since average users could not handle the security risks that resulted from a symmetric design, network managers turned to firewalls as a tool to control access to their machines.

Firewalls for example stand at the gateway between the internal network and the Internet outside. Firewalls are a very useful security tool, but they pose a serious obstacle to peer-to-peer communication models and point out the problem which the disclosed invention secure P-T-P for example resolves via each node on the distributed network seeing all other nodes as just another web server.

Port number for example usually indicated which application was using the network; and a firewall could count on port 80 being only for Web traffic. But precisely because many firewalls allow connections to port 80, other application authors started routing traffic through that port. Streaming audio, instant messaging, remote method invocations, even whole mobile agents are being sent through port 80. Most current peer-to-peer applications have some way to use port 80 as well in order to circumvent network security policies. Naive firewalls are none the wiser; they are unaware that they are passing the exact sorts of traffic the network administrator intended to block, a challenge overcome by the disclosed system and method use of a VPN in one embodiment of the disclosed system and method.

The process, herein listed as “the portal” is a method for turning the idle time on computers on a network into a useful dynamic, interactive portal by replacing the screensaver. This is for computers or computer enabled devices that use high-speed, always on Internet connections.

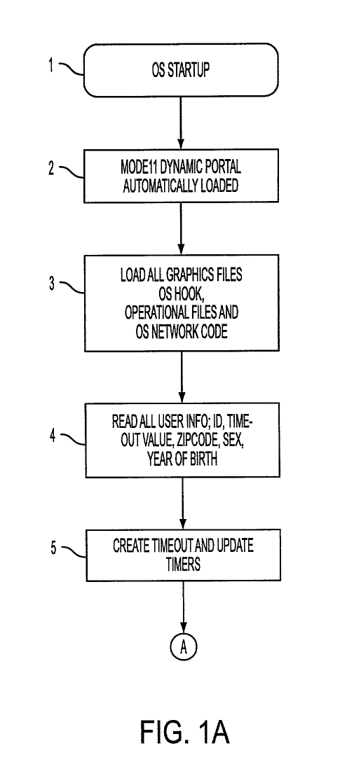

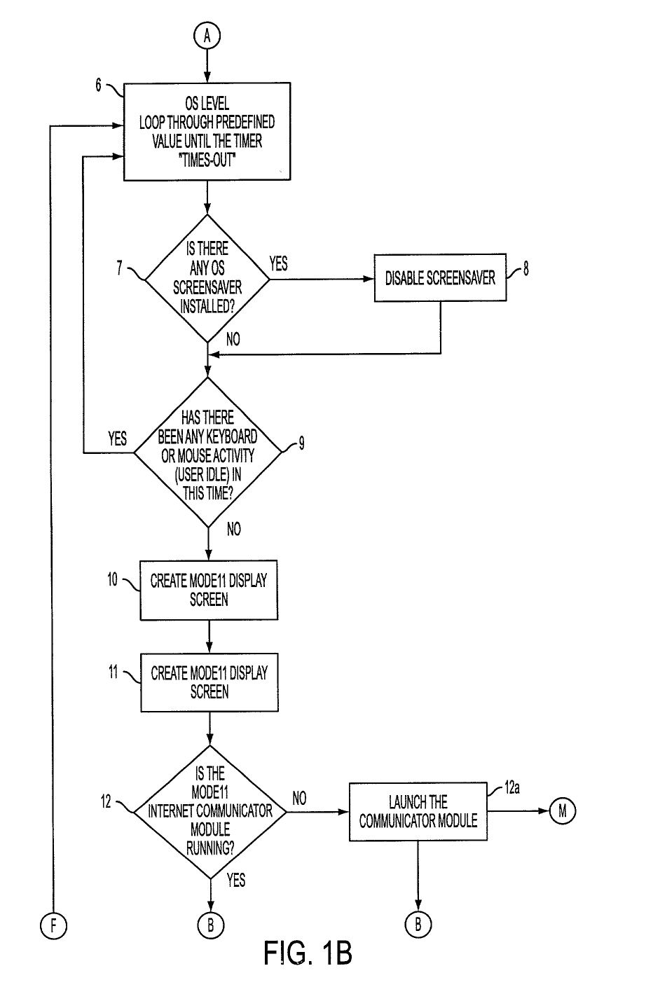

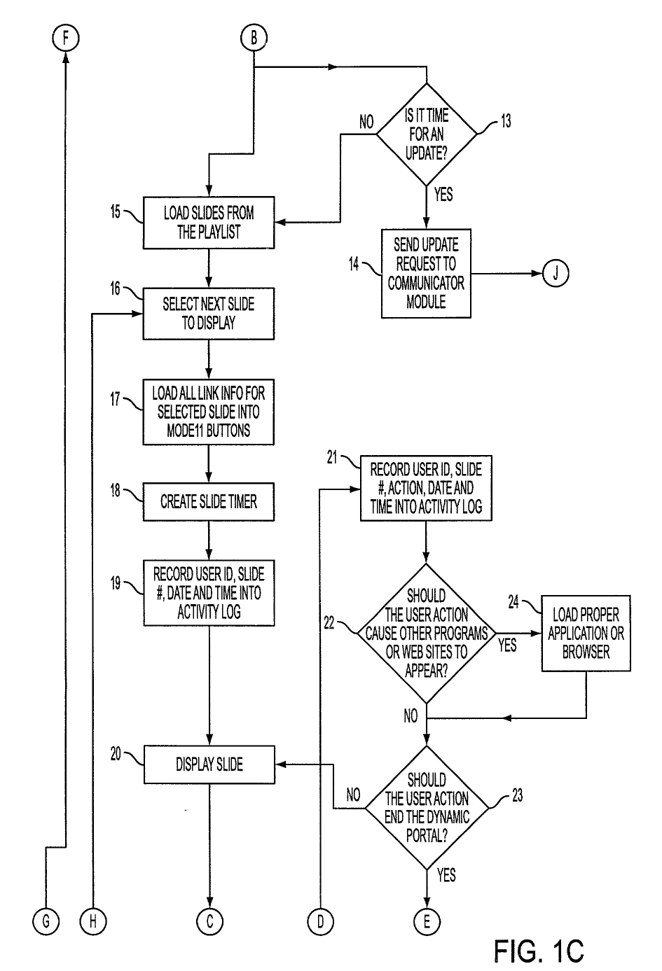

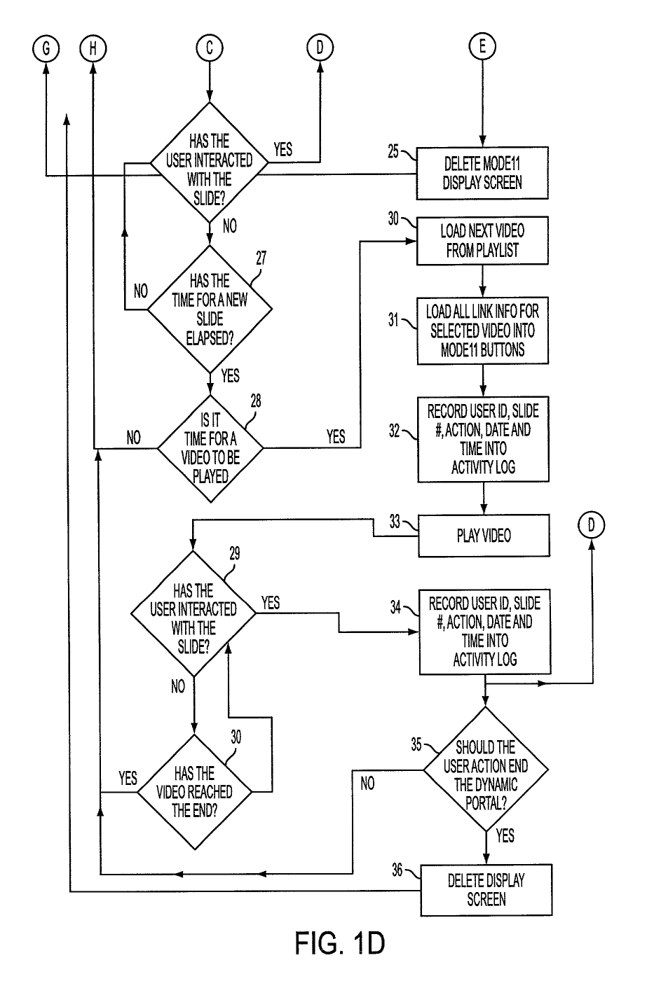

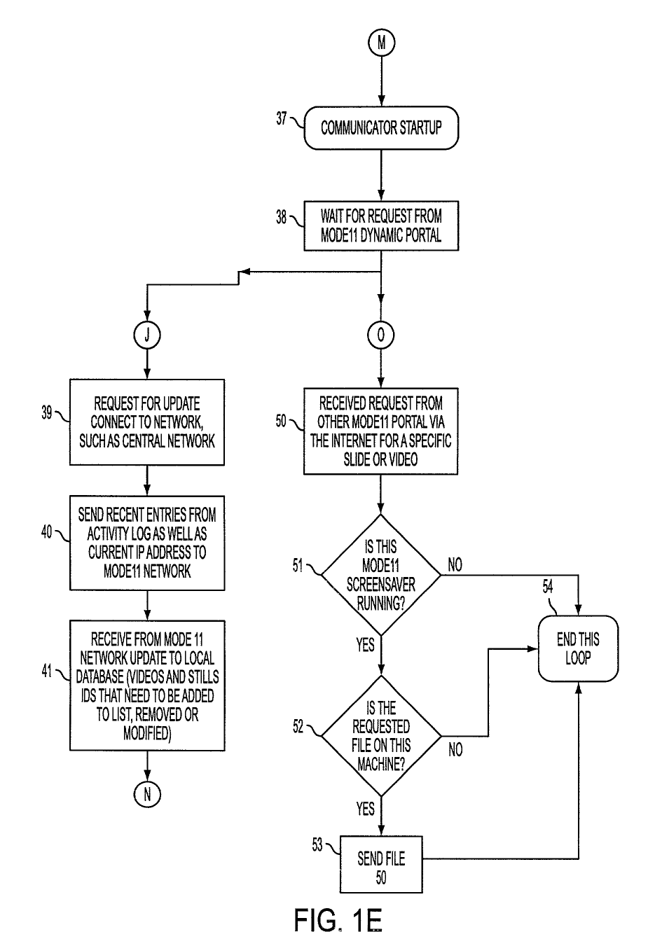

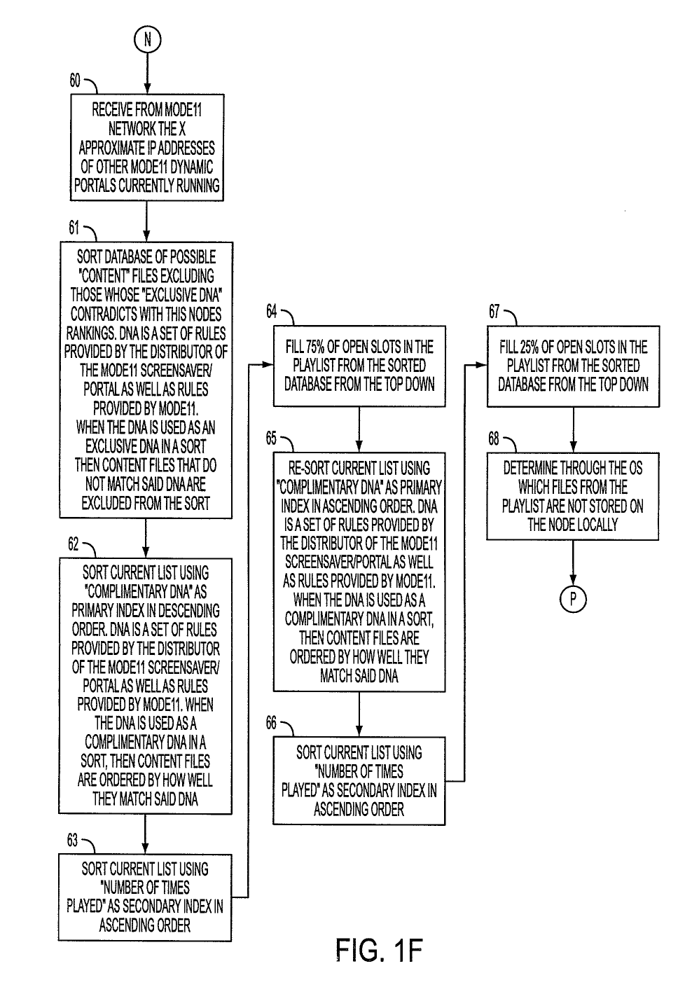

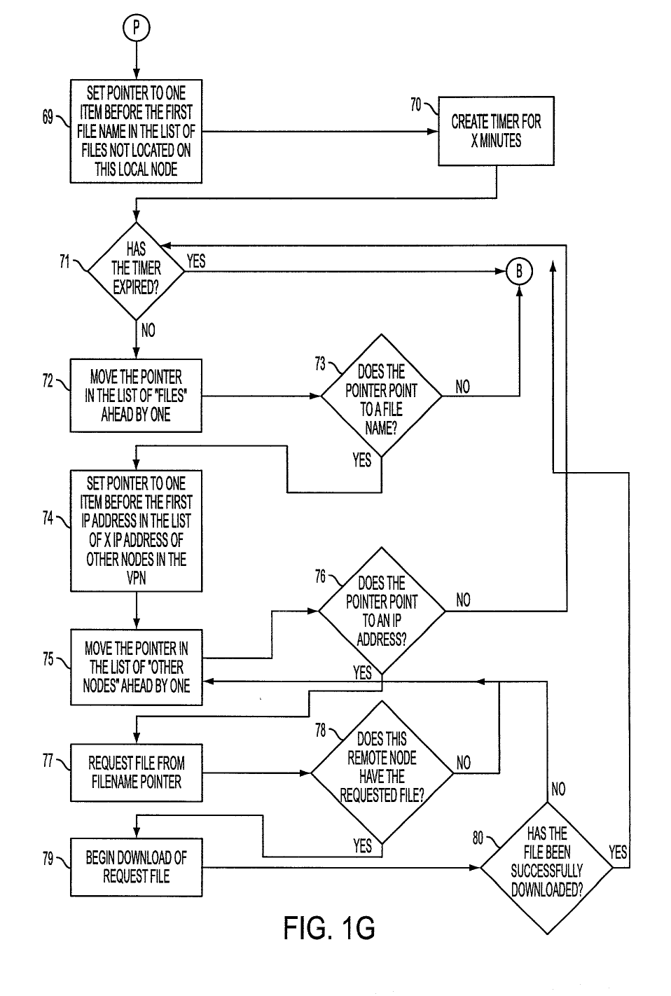

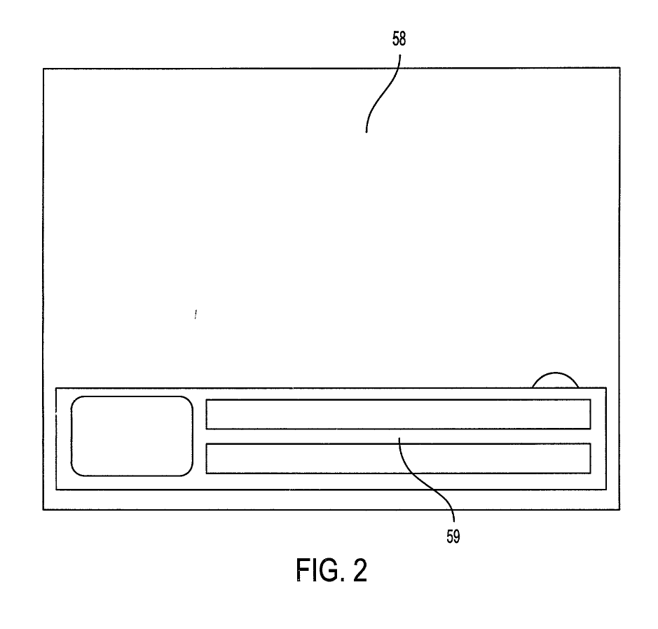

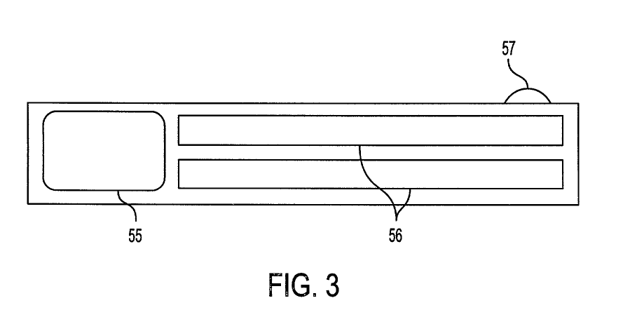

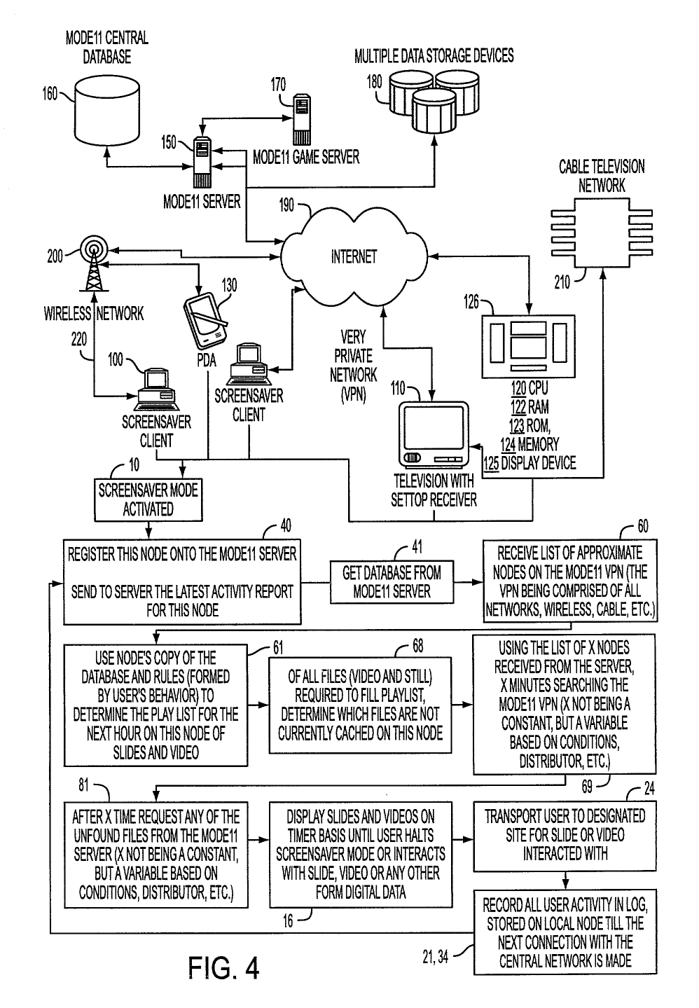

The portal, as shown in FIG. 1 at steps 1 thru 4 executes at computer startup and loads all its graphics files as well as determining the current resolution of the monitor screen as well as other user details from the portal's own database. These graphic files are supplied by and created by the distributor. This allows the portal to have the look, feel and brand-like qualities of the distributors customizable, chosen and selected image. The portal, at step 3, also “hooks” into, for example, an OS such as Windows itself inserting application functionality and, at step 5 creating multiple timers. The timer functionality is used to constantly check for user inactivity, determining the proper time for the portal to update application files from the central network entitled Mode 11 or selected node, as well as when it is time to activate application functionality, such as display a new slide, video or digital information flow.

For example in one embodiment, the application interacts within an operating system such as WINDOWS™ or other OS which provides a facility for hooking many applications occurring within it. In WINDOWS™, hooks can be enabled using SetWindowsHookEx. A dynamic link library (dll) can be written set with a system-wide hook. A typical use of a system-wide hook is to have an application in an executable file that calls a function in the hook dll that calls SetWindowsHookEx for each hook to be used. System-wide hooks is that the hook procedure. The system supports many different types of hooks; each type provides access to a different aspect of its message-handling mechanism. For example, an application can use the WH_MOUSE hook to monitor the message traffic for mouse messages. A system maintains a separate hook chain for each type of hook. A hook chain is a list of pointers to special, application-defined callback functions called hook procedures. When a message occurs that is associated with a particular type of hook, the system passes the message to each hook procedure referenced in the hook chain, one after the other. The action a hook procedure can take depends on the type of hook involved. The hook procedures for some types of hooks can only monitor messages; others can modify messages or stop their progress though the chain, preventing them from reaching the next hook procedure or the destination window.

The system can be used to intercept messages and keystrokes. For example Windows hooks provide a mechanism to intercept messages (including mouse, system or keyboard messages) before they reach their target window. Hook technology allows one to reliably define the scope of the hook, from a specific thread or window, to the entire system. Low level message filtering minimizes performance impact by only notifying the client when desired messages or keystrokes are received. Typical applications for message hooks include: capture the Mouse, Log key and mouse activity for the entire system, detect when any application is activated/de-activated, detect which thread has been activated/de-activated.

A Windows hook is a point in the system message-handling mechanism where an application can install a subroutine to monitor the message traffic in the system for intercepting messages at various points along the message processing sequence. Such subroutines can process certain types of messages (e.g., mouse actions, keystrokes) before they reach the target window procedure.

The subroutine can act on the messages and, in some cases, modify or discard them. The subroutines that receive the events are application-defined callback functions called hook procedures and are classified according to the type of event they intercept. For each type of hook, Windows maintains a separate hook chain, i.e., a list of pointers to some hook procedures. When a message occurs that is associated with a particular type of hook, the system passes the message to each hook procedure referenced in the hook chain, one after another, beginning at the end of the chain. This is known as “calling the hooks.” Attaching one or more hook procedures to a hook is known as “setting the hook.” The action a hook procedure can take depends on the type of hook involved. The hook procedures for some types of hooks can only monitor messages; others can modify messages or stop their progress through the chain, preventing them from reaching the next hook procedure or the destination window.

A hook procedure can be global, monitoring messages for all threads in the system, or it can be thread specific, monitoring messages for an individual thread. Some hooks may be set with system scope only (e.g. WH_SYSMSGFILTER), but most hooks have either system or thread scope. If an application installs a hook procedure for one of its own threads, the hook procedure can be in either the same module as the rest of the application's code or in a DLL. If the application installs a hook procedure for a thread of a different application or a hook procedure with a system-wide scope, the procedure must be in a DLL, otherwise it can't be loaded in the address space of another process. The disclosed application embeds and inserts into an OS hook such as Windows controlling system wide, computer wide, and thread wide all applications.

At step 6 the timer to determine if there is any computer activity is set off. The portal makes sure that there is no other OS such as a Windows enabled screensaver in this embodiment activated at step 7, which it disables at step 8 if there is.

At step 9 activity flags are checked to see if there has been any. If there has been then the routine returns to step 6. Otherwise the portal becomes the active application when it shows itself to the user at step 10. Any picture, icon, button, customized GUI etc., that the portal needs to show to the user is part of this display screen.

The portal then makes sure that its communication application software is running, and if not, the portal loads it at steps 12, and 12a. The communications software, “Communicator”, is the program that communicates with the central network where all update files and database come from. It loads itself, step 37, and then waits to receive a message from the dynamic portal, step 38.

The portal, at step 15, uses the playlist of stills and videos from the last time it ran. In steps 16 through 20 the portal loads all relevant information related to the next slide in the playlist it is about to show. This includes all customizable GUI based applications such as buttons that may or may not have links to other applications or other websites, e.g., clicking the “Buy Now” button on the dynamic toolbar while viewing a slide of jacket that may be illustrated at drawing 65, will transport the user to the website page that is used to purchase that jacket. The portal then records the user, time, and slide info into the activity log and displays the slide on the screen.

Each slide will have its own record and data can be stored in a text file or markup language such as extensible markup language (XML). Slides can be customized for example to feature CNN features, HBO programming, etc.

In one embodiment, the upper 80 percent of the screen (58) hold the graphics and text for this slide although this can be dynamically rearranged. The toolbar (59) is located in one embodiment at the bottom of the screen. It has a customizable logo (55) which can be licensed to the distributor of the portal, multiple customizable controls (“Go to Web”, “Buy Now”, “Bookmark”, Tell a friend”), as well as customizable functionality such as VCR, Volume, Mute and others (56) which are used by the user to navigate or transact with the slide should they wish to. A Mute indicator (57) is also used so with just a glance the user is aware of the current state of the audio.

At step 27, the timer indicating that the current slide should be removed from the screen is automatically activated. If beforehand the user should interact with the slide at step 26 then control is sent to steps 21 through 25. Here the portal records what the user did, what slide was showing, as well as the time into the activity log. Determinations are also made as to whether or not the user's actions should cause other applications or web site are to be brought up, and if the portal is to become inactive and return control to the original timer, step 6.

If the portal makes it to step 27 without any interaction on the user's part, then the video timer, step 28, is checked to see if a video should be thrown into the mix. If this is the case control is then routed to steps 30 through 33 where the process for loading a slide is virtually duplicated. The next video in the playlist is loaded, as are all the links that correspond to the buttons shown during the video. The data is recorded in the activity log and the video is played. The upper 80 percent of the screen (58) can contain the graphics, text and a video for this presentation. In the immediate embodiment, the toolbar (59) is located at the bottom of the screen but can be customized to be positioned anywhere on a screen plane and made opaque or transparent. It has a logo (55) which can be customized to promote the distributor of the portal, multiple controls (“Go to Web”, “Buy Now”, “Bookmark”, Tell a friend”, as well as VCR, Volume, Mute and others functional applications (56) which are used by the user to navigate or transact with the slide should they wish to. A Mute indicator (57) is also used so with just a glance the user is aware of the current state of the audio or other media players. Until the end of video is confirmed at step 30, a timer at step 29 checks for user interaction with the video. These steps are looped until the end of video is confirmed, where control is returned to step 16, the loading of the next slide in the playlist.

While the disclosed invention incorporates any distributed network, the advantage of a peer-to-peer embodiment allows the disclosed invention to share the processing power and storage capacity of networked computer devices even when they run application programs.

Peer-to-peer network operating systems allow users to share devices, files with any networked computer. Files storage and application activity in peer-to-peer networks do not require any single server. Any node on the network can share its drives and environment while running application programs.

User interaction with the video before step 30 returns a ‘Yes’ passes control to steps 34, 35, 36. Here, just as with interaction with a slide, the user's actions are recorded into the activity log, as well as determining whether or not the interaction should cause the termination of the interactive portal and control passed back to step 6.

All these steps constitute the loop of the dynamic interactive portal. During this process step 13, is automatically activated whenever the update timer, created at step 5, times out. This step does not interfere with or halt the any of the other steps. The activation of this timer immediately sends an update request (from step 14) to the communicator module at step 38. The request update has the communicator connect to the Mode11 central server via TCP/IP over the Internet, step 39. Once connected, step 40, the communicator sends over any entries in the activity log, deleting them once they have been transmitted. As well, in the same transmission, the communicator sends over its own IP address. The latest update to the database is sent from the Mode11 central server, step 41, which is used to add, delete or modify entries in the local database.

At step 60, the Mode11 central server can, in one embodiment, intercast over 20 IP addresses of other dynamic portals across the distributed, centralized as well as decentralized networks such as the internet. For example, in one embodiment 10 IP addresses that are just above the communicators IP address, and the 10 that are just below it are intercast in one embodiment (or other variations such as random selection, user determined, sponsor determined are alternative embodiments of address selection.) The communicator module, then uses the database to create a playlist for the next time period, for example, an hour at step 61

The rules that are associated with each “content” file come in form of a two byte code (16 bits). Toggling between a 0 or a 1, each bit merely indicates if the category associated with that bit is to be applied when the local node determines the current playlist.

Each bit can be labeled as is necessary: Bit 1—Theater, Bit 3—Automotive, etc. Such labels are provided for the signals that are setting each “content's” file rules. For example, if only bits 1 and 3 are set for a specific “content” file, this would mean that the contents of that file are directed towards a user who has an interest in theater and cars.

The first byte (8 bits) are determined by the Mode11 server and the second byte is provided by the content distributor; i.e. CNN, NFL, etc. Tagged to the end of the “Rule Strand” are three text rules; Sex, Age, and Zipcode. This tagging allows for even more targeted profiling.

Each “content” file has two rule “strands”, the first strand being used for exclusionary purposes. The second strand being used as a “Complimentary Strand.”

To make use of these “Rule Strands” each local node keeps a ranking meter for each ‘bit’ as well as having some basic info on the user; i.e. “Sex, Year of Birth”, “Zipcode.”

Each meter can have a value ranging from −5 (Negative Sentiment) all the way to +5 (Positive Sentiment). User interaction with content effects each ranking meter. An example would be a “content file” whose “Complimentary Strand” has bits 1 and 3 set. If the user would enact a ‘negative’ action on said “content file” (Mute, Skip, Fast Forward, etc), then the local node's ranking meter for bits 1 and 3 would be decreased by a value of 1. A positive interaction (Unmute, raising volume, Rewind, etc) would cause the same meters to each be raised by a value of 1.

To remove erroneous actions on “content files” as well as identify new users of a node with the Mode11 application already installed, once a week for example, the value of each ranking meter is moved by a value of 1 closer to zero (neutral).

When a local node is about to create a new playlist (the content to be shown during the next hour for example) it takes a sampling of its database of all possible content. This database does not contain the content itself, but each record contains the “content file's” name as well that files “Complimentary Strand” as well as its “Exclusionary Strand.”

The database is sorted into a list (Step 61). During this sort each “Exclusionary Strand” is examined. For example: If record 12 has an “Exclusionary Strand” which has bits 2, 3 and 5 set as well as having the Sex rule set to ‘Male’, then a comparison is done with the local nodes ranking meters. If just one of the meters corresponding with bits 2, 3 and 5 do not have a positive value (1 or higher) than this record is ‘excluded’ from the list being created by the sort. As well, if the local node does not have the user being listed as a ‘Male’ then the list is also ‘excluded’ from the sort. A setting of the ‘Age’ value in the “Exclusionary Strand” means that the user's info must state an age of no more than 5 years difference in either direction for example.

Such a sorted list is now resorted (Step 62) using the “Complimentary Strand” as a primary index. Those records who “strands” have more hits with the “ranking meters” are ordered first. A hit is defined as a ranking meter having a positive value for a corresponding set bit in the “strand.” The higher the ranking in the meter, the higher the hi. For example; if bit 3 in a strand is set, a ranking meter value of 2 would produce a hit value of 2. But if the ranking meter had a value of 5, the hit would be equal to 5. All hits for one strand are added up to determine the strands total hits and its placement in this list during its sort.

(Step 63) The list is then sorted using the records field of “number of times viewed” as a secondary index in ascending order. This means that the list keeps its original sort in step 61, however records that have identical hit values are sorted by this second sort. For example records 225, 34, 23 and 7 are all at the top of list since they had the highest hits value, ‘14’. This secondary index will arrange the records so that the ones that have had the least views will be listed first. The “number of times viewed” is for this node only, and not all the nodes that compromise the entire network.

The play list is then filled up to 75% in one embodiment (Step 64) starting at the top of the nodes newly sorted list. The actual number of available slots depends on the distributor of the Mode11 application and system.

The list is then resorted (Step 65) using the “Complimentary Strand” as the primary index, with records having the least hits listed at the top. A secondary index is then used (Step 66) to make sure that records indicating less views are listed first.

The remaining 25% of the play list in one embodiment is (Step 67) starting at the top of the nodes newly sorted list.

This method of monitoring behavior integrated with the Primary and Secondary indexes helps to solve the problem of being able to target a user with an acceptable margin range, while also allowing for a proper and clean rotation of all applicable content across the network.

The playlist will contain a mixture of videos and stills or other digital media. Starting at step 68, the communicator module begins the process of determining which of the files from the playlist is not stored locally on this node and then proceeds to grab the missing files over the VPN (very private network) in one embodiment.

Searching via the disclosed invention on the Peer-to-Peer Network is in one embodiment accomplished by the following steps:

(Step 69) A pointer for the list of files or data that does not reside on this local node is set to just one level above the first filename. i.e. incrementing this pointer by one will place the pointer at the first filename.

A timer is created for X minutes (Step 70). The value of X can be set by the distributor of the content. It is the allotted time in which a node has to find the missing files or data across the peer-peer network.

A check for the timer expiring (X minutes passing) starts the ‘search’ loop (Step 71). If the timer has expired then the search process has ended and control is sent back to Step 15 once the unfound files are retrieved from the central network (Step 81). If however the timer is still running then the pointer for the list of missing filenames is incremented by one (Step 72). A check is made that the pointer's new location still points to a filename (Step 73). If not, then this indicates that a check was made for all the files and the search process has ended (Step 15).

While there are still filenames to search for (Step 74) a pointer for the list of IP Addresses of X other nodes (just like this pointer doing the searching) on the peer-peer network is set to just one level above the first IP Address. The pointer is for the list of IP Addresses is then incremented by one (Step 75). A check is made that the pointer's new location still points to a valid IP Address (Step 76). If not, then this check indicates every IP Address was checked for the current filename that is being searched for. The control of the loop is then passed to step 71 where, after a timer check, a new search begins for a new file.

As long as step 75 produces a positive IP Address, a request is made from this node to the node identified by the IP Address for the filename being searched (Step 77). If the remote node does not have the requested file (Step 78), control is sent back to step 75, which will cause other IP Addresses to be polled for the missing filename or data. An affirmative answer to the request for the filename will begin a download from the remote node (Step 79).

A successful download of the missing file (Step 80) will pass control of the loop back to step 75. An unsuccessful or aborted download will pass control back to step 79.

The disclosed inventions peer-to-peer intercasting method of using other nodes to supply missing data solves one of the largest problems facing any content provider today. Bandwidth at a central server is expensive. Supplying users with massive amounts of data becomes very costly, very quickly. With the method described above, a content provider need only use their servers for backups, for those times when a node cannot located specific files, or chunks of data from other ‘like’ nodes.

For example in one embodiment of the invention, a “chunk” of a file transfer is part of the process of breaking up a file into data packets. Each packet has a proper beginning of “chunk” header . . . i.e. “BOC” such that when incoming from a data stream, each node that reads the chunk knows where the beginning of the chunk is based apon a CHUNK # right after its tag so that the reading node knows where to put the chunk when assembling all of chunks from other nodes.

A TAG is simply a string of characters for example for a node reading a stream incoming from a network such as the internet:

“34sdfBOC*5sdf6sdf7823df4sf85s4f7s8sd95789932457EOC*92375”; in which “BOC” is a tag to indicate where the “chunk” is starting. If a chunk is using an EOC* tag then the disclosed system and method understands where to stop reading for that incoming chunk conserving precious bandwidth and network consumption an objective of the disclosed system and method.

Either an end of chunk header i.e. “EOC*” allows a receiving node to know it has received a full “chunk” or following the BEGINNING OF CHUNK HEADER, the next 16 bits contain a number (i.e. 10240), and that number would tell the reading node how big the CHUNK is confirming that the node received a whole chunk.

Since this process runs independently of the application that spawned it (i.e. the screensaver application), the disclosed method would work very well for content providers seeking to offer video on demand services. Known video on demand services feed a video stream to every node requesting Video A for example.

The disclosed peer-to-peer method can be used to download “chunks” of said video or digital data from other nodes that currently have for example the same movie loaded. The first node to order a movie would have to download it from a central server. Yet as more and more nodes request the same movie, they can begin to download the movie from other ‘like’ nodes, saving the content provider money on bandwidth as well as infrastructure to provide said bandwidth.

This ability to fetch IP addresses can for example allow for a prioritized peer network broadcast of affinity digital information. Embodiments of the invention comprise an embodiment in which datafiles coming into a node are chosen by the user and not a rules based system as well as an embodiment in which the files being downloaded from other nodes can occur from multiple nodes simultaneously.

Step 50 indicates an incoming request for a specific file from another Mode11 portal out there on the internet. This came from step 47 on the portal making the request. Step 51, determine if the portal is currently active, does the “Display Screen” created at step 10, exist. If yes, then the application queries does the requested file reside on this computer, step 52? If yes, send the requested file over the internet at step 53. Once completed, end this loop, step 54. A negative response from 51 or 52 would go straight to step 54.

Distinct from known portals with limited content news headlines, weather, stock quotes and sports scores such as “My Yahoo” or “My Excite” webpage, the disclosed invention provides a portal application which will automatically begin running on a user's computer after an amount of time that no activity occurred on the computer. Unlike known screensavers, the disclosed invention presents the user a television-like experience by delivering full-video programming and other customized digital information. The advantage of a internetworked functionality unlike television or radio, the disclosed application is fully interactive. Standard video programming can be embellished with links to web sites, surveys and other digital information. Users can even pause and rewind any programming as well as e-mail a selected clip to a network participant. The disclosed application can be customized such that in one embodiment, the application will automatically begin running on a user's computer after an amount of time that no activity occurred on the computer. Unlike known screensavers, the disclosed invention presents the user a television-like experience by delivering full-video and digital programming. The application is “re-purposeable” into for example such embodiments as the three distinct, separate revenue streams of:

Licensing parties may customize versions of the application broadcast network, affinity groups, sports teams, musical acts, and other corporate entities that wish to, will be able to extend their branding and promotions throughout the broadband world, not only with ease, but also with the “broadcast sensibility” that the television and radio industry have perfected over decades.

Corporate licensors can utilize the disclosed invention for internal networks such as an intranet providing an intelligent usage and alternative to the screensaver application with which to maintain communications with employees in many areas, including; internal brand extensions, company specials (“this month, an extra half a point on all 6 month CDs sold”), as well as video training.

With a third embodiment of the network application, computer users are able to access the potential of the convergence between the Internet, television and new digital media forms. Viewers can watch Digital Video guide listings, which samples and directs viewers to videos from entertainment sites out on the internet (i.e. Atomfilms, Icebox, UGO, etc.) or combinations with television-like programming such as news and sports updates, comedy shorts, and music videos. Among the content, the disclosed application entitled Mode11 can stream clips, trailers, teases, advertisements, and promotions with each having transaction buttons (i.e. buy, rent, etc.) bringing the viewer one transaction away from the ad/promotion to purchase (i.e. hitting the ‘Rent’ button while watching a movie preview would take the user straight to the proper page on a delivery service. Various types of promotional content will allow users to click and win cash and prizes instantly (i.e. “You have thirty seconds to click here and win a brand new Palm Pilot”). Mute features, book-marking and proprietary data transmission algorithms will allow maximum convenience while using minimal bandwidth. The disclosed application conserves bandwidth usage to deliver the right message to a user's communication means to conserve bandwidth.

For example Special Feature application Graphical User Interface buttons are shown only on promotions/videos/commercials where they apply. Customizable Toolbar buttons give the viewer VCR type controls as well transactional capabilities with each video clip or digital information.

The disclosed application is fully transactional, all content (video, music, digital applications and advertisements) will guide viewers directly to sponsors' web sites. An optional ‘Wallet’ feature will allow users to click specific broadcast or banner advertisements and instantly purchase products and services with pre-stored payment information. The network can be designed to page a network participant. The network application as well as its customized versions will be marketed to any individuals or institution with access to the internet.

Intranet broadcast versions: allows a corporation to easily and inexpensively mold their network into an efficient and productive communications tool. Employees can be notified of specials, company news, and new training videos available on the Company's broadcast system. Companies will be able to extend their own branding onto employees desktops with high visibility, instant interactive features.

Internet broadcast versions: provide rich media content such as streaming dynamic footage, contests, exclusives and advertisements targeted to the user's specifics likes and interests. Applications include a dynamic Internet listing which samples and points a user to the hottest video on the web. Passive and interactive entertainment with muting and ability to target specific items and sub-populations is provided by the disclosed application with high visibility, instant interactive features.

Other features include a “Win/win” application such that network participant who do not win a contest are steered to product web-sites for exclusive discounts and promotions, free news, stock and securities markets information, weather reports. A screensaver type application and a search-and-select function for choosing content to watch is distributed to a network participant.

The disclosed network application will not require a user to fill out pushy and lengthy questionnaires; profiles are built up unobtrusively while always maintaining a viewer's privacy. Click-Throughs of user ads are recorded and, over time, viewers are asked profiling questions. For example; a user may be asked a question with a multiple choice of answers; “How often do you go to the movies?”

Unlimited access to a broad selection of content at any time; users can view videos, music and digital content by category or ratings. The disclosed application will also have special promotions and discounts, and random giveaways every month.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for a dynamic customizable broadcast application portal active during selected computer time, said process comprising the steps of:
providing an electronic network having client software, said network being connectable thereto by multiple clients having network connectable machines, each machine having a display;
activating the client software based on certain determined criteria after predefined timeout periods for the network connectable machines;
said client software installing said application to the display, said application comprising digital signals;
maintaining selected static functions and applications on said machine; and
intercasting via said network for said portal replication, customization and selected dynamic functions and application updates on said machine.

2. The process of claim 1, wherein said process is implemented during idle computer time.

3. The process of claim 1 further wherein said process replaces a screen saver.

4. The process of claim of 1, wherein said process of selecting at least one of said multiple clients is customized to be random, user-determined, or network participant determined.

5. The process of claim 1, wherein said display contains a screen that is comprised of any combination of both video, stills and audio and wherein a distributor or sponsor can customize times between update to said screens of said display;
wherein a user has the ability to pause or hold a selected screen of said display in place for a time delay control of time flow of view stream.

6. The process of claim 1, wherein said step of intercasting includes providing incentives via selection of said network clients.

7. The process of claim 2, further providing a toolbar for each said of said screens with customizable functionality including but not limited to VCR type navigational controls, wherein said toolbar is dynamically updated and customized at each new update of said screen, comprising video, stationary and digital data and which provide for users of said portal linkages which can instantly transport to other sites on the distributed network such as the internet.

8. The process of claim 3, further comprising the step of:
providing customization of channels for sponsors or affinity “barker channels” for product placement; and
providing from sponsors or affinity “barker channels” real time information signals across said distributed network comprising news or other time sensitive information.

9. The process of claim 4, further comprising the step of:
providing incentives from sponsors or affinity groups in real time;
choosing select users;
intercasting time sensitive promotions with a time-out value, including but not limited to a contest or sweepstake; and
a “win now” functionality comprising a graphical user interface with a button for users to instantly interact with a promotion and automatically alert the provider of the promotion or contest to the users desire to accept the time sensitive promotion or contest.

10. The process of claim 5, further providing steps of:
selecting at least a client in real time by sponsors or affinity groups;
intercasting promotions comprising applications with sponsor customizable graphical user interfaces (GUIs) comprising a “free sample giveaway” with a time-out value;
providing a “receive free sample now” customized GUI comprising a style button for users to instantly interact with a promotion and automatically alert the provider of the promotion or contest to the users choice to accept the time sensitive promotion or contest.

11. The process of claim 6, wherein said step of intercasting includes allowing sponsors or affinity groups to provide real time incentives;
selecting users to be intercast time sensitive promotions comprising of a “special offer” with a time-out value; contacting said users;
providing sponsor customizable GUIs comprising a “special offer now” style button for users to instantly interact with a promotion and automatically alert the provider of the promotion or contest to the users acceptance of the time sensitive incentive including a promotion or contest.

12. The process of claim 7, further comprising;
a real time recording, intercasting and transmission of a user's interactions with the dynamic portal;
wherein said application means builds a demographic database for use by said sponsor or affinity group.

13. The process of claim 8, further comprising the step of providing a customizable multi-tiered layer of timers to signal the portal's activation, update times, update digital applications and video play times.

14. The process of claim 9, further comprising the steps of:
transferring files in predetermined size chunks;
numbering said chunks;
using said chunk numbers to continue disrupted file transfers.

15. The process of claim 10, further providing the steps of:
updating in real time functionality features for user to user intercasting;
wherein said functionality features allow selection of predefined time periods where the signals are automatically muted; and
wherein said signal comprises audio, video, or digital program streaming.

16. The process of claim 1, wherein said network is peer-to-peer.

17. The process of claim 1, wherein said network is a Very Private Network.

18. The process of claim 1, wherein said network is wireless.

19. The process of claim 1, further comprising a markup language.

20. A process for a dynamic customizable broadcast application portal active during selected computer time, said process comprising the steps of:
initiating communication, upon activation, from a client to a server computer on a network;
delivering from said client to said server identification information to allow said server to record process activity regarding the activities within the domain of the client software processes;
requesting a current version of rules from said server by said client, said current version determining content and order of information to be delivered to said client computer;
integrating said rules delivered to said client from said server into a preexisting rules list;
requesting by said client from said server, other proximate positioned computers on the network;
initiating a process, based upon said current rules a determination of information said client computer will request from other proximate positioned computers on the network;
contacting said proximate computers on said network by said client;
requesting information that has been determined by the application of the rules in previous software process; determining whether said proximate computers on the network contain said information being requested by said client;
intercasting said information from said proximate computers on said network;
obtaining information that was unavailable from the proximate computers on said network from said server;
parsing the information that has been received based upon most recent rules;
displaying the information obtained in the order determined in the previous process;
delivering the information obtained to the device determined by the application of rules, and based upon said previous rules embedded in the process;
delivering the information obtained to the device determined by the application of rules based upon the previous rules embedded in said process;
allowing for interaction by a user within components of said process that is running on the client computer;
displaying the information determined by application of said rules running on the client computer;
delivering the information determined by application of said rules running on the client computer;
recording the details of all interactions with the interface on said client computer;
recording all the details of interactions whether accidental or deliberate with various interface components of said client computer;
intercasting periodically, based upon most recent rules information recorded by said client to said server in the process;
requesting periodically from said server to said client current rules to be implemented within processes on said client computer.

21. The process of claim 20, further comprising the steps of
fetching via a peer from a local node a rules based database to a preferred node comprising a server or other nodes to find nodes with active content; and
intercasting needed content to said nodes requiring additional required content and applications based upon said rules.

22. A preferred peer-to-peer network process for broadcasting digital applications across a digital network, said process comprising the steps of:
communicating peer-to-peer to server applications via a screensaver substitution application;
intercasting peer-to-peer to server affinity incentives;
providing a prioritized peer broadcasting application within a VPN;
providing a real-time rules based server-client peer-to-peer application capable of contacting proximate computers on said network;
requesting via a client peer information that has been determined by said application of rules in a previous proximate peer run of said process;
intercasting via said proximate client peer said information that has been determined by said application of the rules to fulfill request; and
updating all peer-to-peer to client applications via said information.

23. The process of claim 22, further comprising the steps of
intercasting peer-to-peer to server to PDA digital signals;
intercasting peer-to-peer to server to a Television with a settop Receiver digital signals;
intercasting peer-to-peer to server to a wireless network digital signals;
intercasting peer-to-peer to server to a Cable Television Network digital signals;
intercasting peer-to-peer to server digital signals to a machine comprising a CPU, RAM, ROM Memory, and a Display Device;
intercasting peer-to-peer to server digital signals to at least one data storage device; and
intercasting peer-to-peer to server digital signals to a network within a network.

24. The process of claim 22 further comprising the steps of:
intercasting from a game server;
intercasting from a centralized database server; and
intercasting from at least one data storage device.

25. The process of claim 22, further comprising the steps of:
intercasting from a preferred client as a game server; and
